(19) United States
(12) Patent Application Publication
(10) Pub. No.: US 2012/0046399 A1
(43) Pub. Date: Feb. 23, 2012

(54) NANOCOMPOSITE BLENDS WITH POLYESTERS

(75) Inventors: Sachin Jain, Mannheim (DE); Claus Gabriel, Griesheim (DE); Alexander Traut, Schriesheim (DE)

(73) Assignee: BASF SE, Ludwigshafen (DE)

(21) Appl. No.: 13/212,566

(22) Filed: Aug. 18, 2011

Related U.S. Application Data
(60) Provisional application No. 61/375,057, filed on Aug. 19, 2010.

(51) Int. Cl. C08K 5/5445; B82Y 30/00

(52) U.S. Cl. 524/188; 977/773

(57) ABSTRACT

Thermoplastic molding compositions comprising
A) from 10 to 98.95% by weight of at least one thermoplastic polyester,
B) from 0.05 to 30% by weight
   of at least one nanoparticulate oxide and/or oxide hydrate of at least one metal or of at least one semimetal with a number-average primary particle diameter of from 0.5 to 50 nm and with a hydrophobic particle surface,
C) from 1 to 60% by weight of at least one graft polymer, composed of
   c₁) from 20 to 80% by weight of a graft base composed of an elastomeric polymer based on alkyl acrylates having from 1 to 8 carbon atoms in the alkyl moiety and/or dienes having a glass transition temperature below 10° C.
   c₂) from 20 to 80% by weight of a graft composed of
   c₂₁) from 60 to 95% by weight of styrene or of substituted styrenes of the general formula I

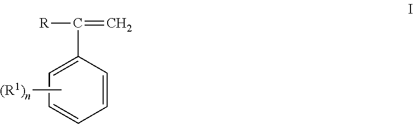

where R is an alkyl radical having from 1 to 8 carbon atoms or a hydrogen atom, and R¹ is an alkyl radical having from 1 to 8 carbon atoms, and n is 1, 2, or 3, and
c₂₂) from 5 to 40% by weight of at least one unsaturated nitrile,
D) from 0 to 60% by weight of further additives,
   where the total of the percentages by weight of components A) to D) is 100%.

The invention relates to thermoplastic molding compositions comprising

A) from 10 to 98.95% by weight of at least one thermoplastic polyester,
B) from 0.05 to 30% by weight
of at least one nanoparticulate oxide and/or oxide hydrate of at least one metal or of at least one semimetal with a number-average primary particle diameter of from 0.5 to 50 nm and with a hydrophobic particle surface,
   C) from 1 to 60% by weight of at least one graft polymer, composed of
c₁) from 20 to 80% by weight of a graft base composed of an elastomeric polymer based on alkyl acrylates having from 1 to 8 carbon atoms in the alkyl moiety and/or dienes having a glass transition temperature below 10° C.
c₂) from 20 to 80% by weight of a graft composed of
c₂₁) from 60 to 95% by weight of styrene or of substituted styrenes of the general formula I

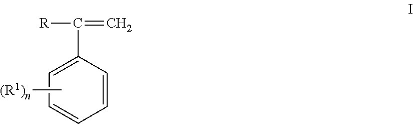

where R is an alkyl radical having from 1 to 8 carbon atoms or a hydrogen atom, and R¹ is an alkyl radical having from 1 to 8 carbon atoms, and n is 1, 2, or 3, and
c₂₂) from 5 to 40% by weight of at least one unsaturated nitrile,
   D) from 0 to 60% by weight of further additives,
   where the total of the percentages by weight of components A) to D) is 100%.

The invention further relates to the use of the thermoplastic molding compositions for producing fibers, foils, and moldings, and also to fibers, foils, and moldings which are obtainable from the thermoplastic molding compositions of the invention.

It is known that polyesters can be modified with rubbers. Among the rubbers that are suitable for these purposes are inter alia those based on ASA and/or ABS.

Examples of polyesters and nanoparticles are known from CN-A 10/1423656, CN-A 1/687230, and 10/1407630, for example.

The mechanical properties of the known blends comprising a combination of rubber and nanoparticles are not fully satisfactory.

It was therefore an object of the present invention to provide blends of polyester with ASA/ABS rubbers which, with nanoparticles, are to have good processability together with improved mechanical properties (in particular notched impact resistance).

The molding compositions defined in the introduction have accordingly been discovered. Preferred embodiments are given in the dependent claims.

The molding compositions of the invention comprise, as component (A), from 10 to 98.95% by weight, preferably from 20 to 94% by weight, and in particular from 30 to 90% by weight, of at least one thermoplastic polyester.

Use is generally made of polyesters A) based on aromatic dicarboxylic acids and on an aliphatic or aromatic dihydroxy compound.

A first group of preferred polyesters is that of polyalkylene terephthalates, in particular those having from 2 to 10 carbon atoms in the alcohol moiety.

Polyalkylene terephthalates of this type are known per se and are described in the literature.

Their main chain comprises an aromatic ring which derives from the aromatic dicarboxylic acid. There may also be substitution in the aromatic ring, e.g. by halogen, such as chlorine or bromine, or by C₁-C₄-alkyl, such as methyl, ethyl, iso- or n-propyl, or n-, iso- or tert-butyl.

These polyalkylene terephthalates may be prepared by reacting aromatic dicarboxylic acids, or their esters or other ester-forming derivatives, with aliphatic dihydroxy compounds in a manner known per se.

Preferred dicarboxylic acids are 2,6-naphthalenedicarboxylic acid, terephthalic acid and isophthalic acid, and mixtures of these. Up to 30 mol %, preferably not more than 10 mol %, of the aromatic dicarboxylic acids may be replaced by aliphatic or cycloaliphatic dicarboxylic acids, such as adipic acid, azelaic acid, sebacic acid, dodecanedioic acids and cyclohexanedicarboxylic acids.

Preferred aliphatic dihydroxy compounds are diols having from 2 to 6 carbon atoms, in particular 1,2-ethanediol, 1,3-propanediol, 1,4-butanediol, 1,6-hexanediol, 1,4-hexanediol, 1,4-cyclohexanediol, 1,4-cyclohexanedimethanol and neopentyl glycol, and mixtures of these.

Particularly preferred polyesters (A) are polyalkylene terephthalates derived from alkanediols having from 2 to 6 carbon atoms. Among these, particular preference is given to polyethylene terephthalate, polypropylene terephthalate and polybutylene terephthalate, and mixtures of these. Preference is also given to PET and/or PBT which comprise, as other monomer units, up to 1% by weight, preferably up to 0.75% by weight, of 1,6-hexanediol and/or 2-methyl-1,5-pentanediol.

The intrinsic viscosity of the polyesters (A) is generally in the range from 50 to 220, preferably from 80 to 160 measured in 0.5% strength by weight solution in a phenol/o-dichlorobenzene mixture (in a weight ratio of 1:1) at 25° C. in accordance with ISO 1628.

Particular preference is given to polyesters whose carboxyl end group content is up to 100 mval/kg of polyester, preferably up to 50 mval/kg of polyester and in particular up to 40 mval/kg of polyester. Polyesters of this type may be prepared, for example, by the process of DE-A 44 01 055. The carboxyl end group content is usually determined by titration methods (e.g. potentiometry).

Particularly preferred molding compositions comprise, as component A), a mixture of polyesters other than PBT, for example polyethylene terephthalate (PET). The proportion of the polyethylene terephthalate, for example, in the mixture is preferably up to 50% by weight, in particular from 10 to 35% by weight, based on 100% by weight of A).

It is also advantageous to use PET recyclates (also termed scrap PET), optionally mixed with polyalkylene terephthalates, such as PBT.

Recyclates are generally:
1) those known as post-industrial recyclates: these are production wastes during polycondensation or during processing, e.g. sprues from injection molding, start-up material from injection molding or extrusion, or edge trims from extruded sheets or films.
2) post-consumer recyclates: these are plastic items which are collected and treated after utilization by the end consumer. Blow-molded PET bottles for mineral water, soft drinks and juices are easily the predominant items in terms of quantity.

Both types of recyclate may be used either as ground material or in the form of pellets. In the latter case, the crude recyclates are separated and purified and then melted and pelletized using an extruder. This usually facilitates handling and free flow, and metering for further steps in processing.

The recyclates used may either be pelletized or in the form of regrind. The edge length should not be more than 10 mm, preferably less than 8 mm.

Because polyesters undergo hydrolytic cleavage during processing (due to traces of moisture) it is advisable to predry the recyclate. The residual moisture content after drying is preferably <0.2%, in particular <0.05%.

Another group to be mentioned is that of fully aromatic polyesters deriving from aromatic dicarboxylic acids and aromatic dihydroxy compounds.

Suitable aromatic dicarboxylic acids are the compounds previously described for the polyalkylene terephthalates. The mixtures preferably used are composed of from 5 to 100 mol % of isophthalic acid and from 0 to 95 mol % of terephthalic acid, in particular from about 50 to about 80% of terephthalic acid and from 20 to about 50% of isophthalic acid.

The aromatic dihydroxy compounds preferably have the formula

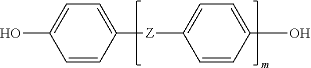

where Z is an alkylene or cycloalkylene group having up to 8 carbon atoms, an arylene group having up to 12 carbon atoms, a carbonyl group, a sulfonyl group, oxygen or sulfur, or a chemical bond, and m is from 0 to 2. The phenylene groups of the compounds may also have substitution by C₁-C₆-alkyl or alkoxy and fluorine, chlorine or bromine.

Examples of parent compounds for these compounds are

dihydroxybiphenyl,
di(hydroxyphenyl)alkane,
di(hydroxyphenyl)cycloalkane,
di(hydroxyphenyl) sulfide,
di(hydroxyphenyl)ether,
di(hydroxyphenyl) ketone,
di(hydroxyphenyl) sulfoxide,
α,α′-di(hydroxyphenyl)dialkylbenzene,

di(hydroxyphenyl) sulfone, di(hydroxybenzoyl)benzene,

resorcinol, and
hydroquinone, and also the ring-alkylated and ring-halogenated derivatives of these.

Among these, preference is given to

4,4′-dihydroxybiphenyl,
2,4-di(4′-hydroxyphenyl)-2-methylbutane,
α,α′-di(4-hydroxyphenyl)-p-diisopropylbenzene,
2,2-di(3′-methyl-4′-hydroxyphenyl)propane, and
2,2-di(3′-chloro-4′-hydroxyphenyl)propane,
and in particular to
2,2-di(4′-hydroxyphenyl)propane,
2,2-di(3′,5-dichlorodihydroxyphenyl)propane,
1,1-di(4′-hydroxyphenyl)cyclohexane,
3,4′-dihydroxybenzophenone,
4,4′-dihydroxydiphenyl sulfone and
2,2-di(3′,5′-dimethyl-4′-hydroxyphenyl)propane
and mixtures of these.

It is, of course, also possible to use mixtures of polyalkylene terephthalates and fully aromatic polyesters. These generally comprise from 20 to 98% by weight of the polyalkylene terephthalate and from 2 to 80% by weight of the fully aromatic polyester.

It is, of course, also possible to use polyester block copolymers, such as copolyetheresters. Products of this type are known per se and are described in the literature, e.g. in U.S. Pat. No. 3,651,014. Corresponding products are also available commercially, e.g. Hytrel® (DuPont).

According to the invention, polyesters include halogen-free polycarbonates. Examples of suitable halogen-free polycarbonates are those based on diphenols of the formula

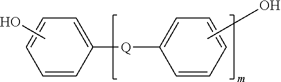

where Q is a single bond, a C₁-C₈-alkylene group, a C₂-C₃-alkylidene group, a C₃-C₆-cycloalkylidene group, a C₆-C₁₂-arylene group, or —O—, —S— or —SO₂—, and m is a whole number from 0 to 2.

The phenylene radicals of the diphenols may also have substituents, such as C₁-C₆-alkyl or C₁-C₆-alkoxy.

Examples of preferred diphenols of the formula are hydroquinone, resorcinol, 4,4′-dihydroxybiphenyl, 2,2-bis(4-hydroxyphenyl)propane, 2,4-bis(4-hydroxyphenyl)-2-methylbutane and 1,1-bis(4-hydroxyphenyl)cyclohexane. Particular preference is given to 2,2-bis(4-hydroxyphenyl)propane and 1,1-bis(4-hydroxyphenyl)cyclohexane, and also to 1,1-bis(4-hydroxyphenyl)-3,3,5-trimethylcyclohexane.

Either homopolycarbonates or copolycarbonates are suitable as component A, and preference is given to the copolycarbonates of bisphenol A, as well as to bisphenol A homopolymer.

Suitable polycarbonates may be branched in a known manner, specifically and preferably by incorporating 0.05 to 2.0 mol %, based on the total of the biphenols used, of at least trifunctional compounds, for example those having three or more phenolic OH groups.

Polycarbonates which have proven particularly suitable have relative viscosities ηᵣₑₗ of from 1.10 to 1.50, in particular from 1.25 to 1.40. This corresponds to an average molar mass M_{w} (weight-average) of from 10 000 to 200 000 g/mol, preferably from 20 000 to 80 000 g/mol.

The diphenols of the general formula are known per se or can be prepared by known processes.

The polycarbonates may, for example, be prepared by reacting the diphenols with phosgene in the interfacial process, or with phosgene in the homogeneous-phase process (known as the pyridine process), and in each case the desired molecular weight may be achieved in a known manner by using an appropriate amount of known chain terminators. (In relation to polydiorganosiloxane-containing polycarbonates see, for example, DE-A 33 34 782.)

Examples of suitable chain terminators are phenol, p-tert-butylphenol, or else long-chain alkylphenols, such as 4-(1,3-tetramethylbutyl)phenol as in DE-A 28 42 005, or monoalkylphenols, or dialkylphenols with a total of from 8 to 20 carbon atoms in the alkyl substituents as in DE-A-35 06 472, such as p-nonylphenol, 3,5-di-tert-butylphenol, p-tert-octylphenol, p-dodecylphenol, 2-(3,5-dimethylheptyl)phenol and 4-(3,5-dimethylheptyl)phenol.

For the purposes of the present invention, halogen-free polycarbonates are polycarbonates composed of halogen-free biphenols, halogen-free chain terminators, and optionally halogen-free branching agents, where the content of subordinate amounts at the ppm level of hydrolyzable chlorine, resulting, for example, from the preparation of the polycarbonates with phosgene in the interfacial process, is not regarded as meriting the term halogen-containing for the purposes of the invention. Polycarbonates of this type with contents of hydrolyzable chlorine at the ppm level are halogen-free polycarbonates for the purposes of the present invention.

Other suitable components A) which may be mentioned are amorphous polyester carbonates, where during the preparation process phosgene has been replaced by aromatic dicarboxylic acid units, such as isophthalic acid and/or terephthalic acid units. Reference may be made at this point to EP-A 711 810 for further details.

EP-A 365 916 describes other suitable copolycarbonates having cycloalkyl radicals as monomer units.

It is also possible for bisphenol A to be replaced by bisphenol TMC. Polycarbonates of this type are obtainable from Bayer with the trademark APEC HT®.

The content of component B) is from 0.05 to 30% by weight, preferably from 0.05 to 10% by weight, and in particular from 1 to 5% by weight, based on A) to D).

Component B) in the invention is at least one nanoparticulate oxide and/or oxide hydrate of at least one metal or at least one semimetal with a number-average primary particle diameter of from 0.5 to 50 nm and with a hydrophobic particle surface. Appropriate oxides and/or oxide hydrates with a hydrophobic particle surface are known per se to the person skilled in the art.

Component B) can in particular be characterized on the basis of at least one of the following features a) and/or b):
a) Component B) is at least one nanoparticulate oxide and/or oxide hydrate of at least one metal or of at least one semimetal with a number-average primary particle diameter of from 0.5 to 50 nm.
b) The methanol-wettability of component B) is at least 50%.

Methanol-wettability measures the hydrophobicity of an oxide and/or oxide hydrate of at least one metal or semimetal. The method wets oxides and/or oxide hydrates with a methanol/water mixture. The proportion of methanol in the mixture, expressed as percent by weight, is a measure of the water-repellency of the metal oxide. The higher the proportion of methanol, the greater the hydrophobization of the substance.

Titration is used to determine the level of hydrophobicity. For this, 0.2 g of the specimen is weighed into a 250 ml separating funnel, and 50 ml of ultrapure water are added. The oxide or oxide hydrate with hydrophobic surface remains on the surface of the water. Methanol is now added ml-wise from a burette. During this process, the separating funnel is shaken by hand with a circular motion, avoiding production of any turbulence within the liquid. This method is used to add methanol until the powder is wetted. This is discernible in that all of the powder sinks from the surface of the water. The amount of methanol consumed is converted to % by weight of methanol and stated as methanol-wettability value.

The number-average diameter of the primary particles in the thermoplastic molding composition is determined by transmission electron microscopy followed by image analysis, using a statistically significant number of specimens. The person skilled in the art is aware of appropriate methods.

The BET surface area of oxides with hydrophobic particle surface is generally at most 300 m²/g to DIN 66131. The BET specific surface area of component B) to DIN 66131 is preferably from 50 to 300 m²/g, in particular from 100 to 250 m²/g.

The metal and/or semimetal of component B) is preferably silicon. The thermoplastic molding compositions of the invention preferably comprise, as component B), a nanoparticulate oxide and/or oxide hydrate of silicon with a number-average primary particle diameter of from 0.5 to 50 nm, in particular from 1 to 20 nm.

Component B) is particularly preferably fumed nanoparticulate silicon dioxide, the surface of which has been hydrophobically modified.

It is particularly preferable that component B) has a number-average primary particle diameter of from 1 to 20 nm, with preference from 1 to 15 nm.

In one preferred embodiment, component B) has been hydrophobically modified by a surface modifier, preferably an organosilane.

The surface can be modified by bringing the nanoparticles, preferably in the form of suspension, or undiluted, into contact with a surface modifier, for example by spraying.

In particular, the nanoparticles can be sprayed first with water and then with the surface modifier. The reverse spraying sequence can also be used. The water used can have been acidified with an acid, such as hydrochloric acid, until pH is from 7 to 1. If a plurality of surface modifiers are used, these can be applied in the form of a mixture or separately, simultaneously, or in sequence.

The surface modifier(s) can have been dissolved in suitable solvents. Once the spraying process has ended, mixing can be continued for from 5 to 30 minutes. The mixture is then preferably heat-treated for a period of from 0.1 to 6 h at a temperature of from 20 to 400° C. The heat treatment can take place under inert gas, such as nitrogen.

In a possible alternative method for surface-modification of the silicas, the silicas are treated with the surface modifier in vapor form, and the mixture is then heat-treated for a period of from 0.1 to 6 h at a temperature of from 50 to 800° C. The heat treatment can take place under inert gas, such as nitrogen. The heat treatment can also take place in a plurality of stages at different temperatures. The surface modifier(s) can be applied using single- or double-fluid nozzles, or using ultrasound nozzles.

A possible method of surface modification uses heatable mixers and dryers with spray equipment, continuously or batchwise. Examples of suitable apparatuses can be: plowshare mixers, pan dryers, or fluidized-bed dryers.

DE 10 2007 035 951 A1, paragraph [0015], describes surface modifiers that can be used with advantage for the purposes of the present invention.

The following silanes can be used with preference as surface modifiers: octyltrimethoxysilane, octyltriethoxysilane, hexamethyldisilazane, 3-methacryloyloxypropyltrimethoxysilane, 3-methacryloyloxypropyltriethoxysilane, hexadecyltrimethoxysilane, hexadecyltriethoxysilane, dimethylpolysiloxane, glycidyloxypropyltrimethoxysilane, glycidyloxypropyltriethoxysilane, nonafluorohexyltrimethoxysilane, tridecafluorooctyltrimethoxysilane, tridecafluorooctyltriethoxysilane, aminopropyltriethoxysilane, hexamethyldisilazane.

It is particularly preferable to use hexamethyldisilazane, hexadecyltrimethoxysilane, dimethylpolysiloxane, octyltrimethoxysilane, and octyltriethoxysilane.

In particular, those used are hexamethyldisilazane, octyltrimethoxysilane, and hexadecyltrimethoxysilane, very particular preference being given to hexamethyldisilazane.

Amounts of from 1 to 60% by weight, based on the entirety of components A to D, of a graft copolymer or of a mixture of different graft copolymers are used as component C) in the molding compositions of the invention. Preferred molding compositions of the invention comprise from 5 to 50% by weight, particularly preferably from 6 to 45% by weight, of at least one graft copolymer C, which differs from possible further elastomeric polymers D).

The graft polymers C are composed of
c₁) from 20 to 80% by weight, preferably from 50 to 70% by weight, of a graft base composed of an elastomeric polymer based on alkyl acrylates having from 1 to 8 carbon atoms in the alkyl moiety and/or dienes having a glass transition temperature below 10° C.
c₂) from 20 to 80% by weight, preferably from 30 to 50% by weight, of a graft composed of
c₂₁) from 60 to 95% by weight, preferably from 70 to 85% by weight, of styrene or of substituted styrenes of the general formula I

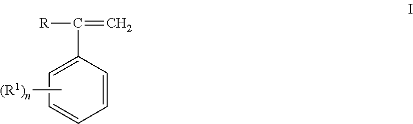

where R is a C₁-C₈-alkyl radical, preferably methyl or ethyl, or hydrogen, and R¹ is a C₁-C₈-alkyl radical, preferably methyl or ethyl, and n is 1, 2, or 3, or a mixture of these, and
c₂₂) from 5 to 40% by weight, preferably from 15 to 30% by weight, of at least one unsaturated nitrile, preferably acrylonitrile or methacrylonitrile, or a mixture of these.

Polymers which may be used for the graft base c₁ are those whose glass transition temperature is below 10° C., preferably below 0° C., particularly preferably below −20° C. Examples of these are elastomers based on C₁-C₈-alkyl esters of acrylic acid and/or dienes, which may optionally comprise other comonomers.

Preferred graft bases c₁ are those composed of
c₁₁) from 70 to 99.9% by weight, preferably 99% by weight, of at least one alkyl acrylate having from 1 to 8 carbon atoms in the alkyl radical, preferably n-butyl acrylate and/or 2-ethylhexyl acrylate, in particular n-butyl acrylate as sole alkyl acrylate, isoprene or butadiene as diene monomers,
c₁₂) from 0 to 30% by weight, in particular from 20 to 30% by weight, of another copolymerizable monoethylenically unsaturated monomer, e.g. butadiene, isoprene, styrene, acrylonitrile, methyl methacrylate, or vinyl methyl ether, or a mixture of these,
c₁₃) from 0.1 to 5% by weight, preferably from 1 to 4% by weight, of a copolymerizable, polyfunctional, preferably bi- or trifunctional, monomer which brings about crosslinking.

Suitable bi- or polyfunctional crosslinking monomers c₁₃) here are those which preferably comprise two, or optionally three or more, ethylenic double bonds capable of copolymerization and not conjugated in 1,3-positions. Examples of suitable crosslinking monomers are divinylbenzene, diallyl maleate, diallyl fumarate, diallyl phthalate, triallyl cyanurate, or triallyl isocyanurate. The acrylic ester of tricyclodecenyl alcohol has proven to be a particularly advantageous crosslinking monomer (cf. DE-A 12 60 135).

This type of graft base is known per se and described in the literature, e.g. in DE-A 31 49 358.

Among the grafts c₂, preference is given to those in which c₂₁ is styrene or α-methylstyrene or a mixture of these, and in which c₂₂ is acrylonitrile or methacrylonitrile. Preferred monomer mixtures used are especially styrene and acrylonitrile or α-methylstyrene and acrylonitrile. The grafts are obtainable via copolymerization of components c₂₁ and c₂₂.

The graft base c₁ of the graft polymers C) is composed of the components c₁₁ and optionally c₁₂, and c₂₂, and is also termed ASA rubber. Its preparation is known per se and is described by way of example in DE-A 28 26 925, DE-A 31 49 358, and DE-A 3414 118. If the graft base is composed of dienes, this is termed ABS rubber, see DE-A 22 44 519.

The graft polymers C may be prepared by the methods described in DE-C 12 60135 or WO 2008/101888, for example.

The construction of the graft (graft shell) of the graft polymers may involve one or two stages. In the case of single-stage construction of the graft shell, a mixture of the monomers c₂₁ and c₂₂ in the desired ratio by weight in the range from 95:5 to 50:50, preferably from 90:10 to 65:35, is polymerized in the presence of the elastomer c₁, in a manner known per se (cf., for example, DE-A 28 26 925), preferably in emulsion.

In the case of two-stage construction of the graft shell c₂, the 1st stage generally makes up from 20 to 70% by weight, preferably from 25 to 50% by weight, based on c₂. Its preparation preferably uses only styrene or substituted styrenes, or a mixture of these (c₂₁).

The 2nd stage of the graft shell generally makes up from 30 to 80% by weight, in particular from 50 to 75% by weight, based in each case on c₂. Its preparation uses mixtures composed of the monomers c₂₁ and of the nitriles c₂₂, in a c₂₁/c₂₂ ratio by weight which is generally from 90:10 to 60:40, in particular from 80:20 to 70:30.

The selection of the conditions for the graft polymerization process is preferably such that the particle sizes obtained are from 50 to 700 nm (d₅₀ value from the cumulative weight distribution). Measures for this purpose are known and are described by way of example in DE-A 2826925.

The seed latex process can be used directly to prepare a coarse-particle rubber dispersion.

In order to obtain products of maximum toughness, it is often advantageous to use a mixture of at least two graft polymers with different particle size.

To achieve this, the particles of the rubber are enlarged in a known manner, e.g. via agglomeration, thus giving the latex a bimodal composition (from 50 to 180 nm and from 200 to 700 nm).

One preferred embodiment uses a mixture composed of two graft polymers with particle diameters (d₅₀ value from the cumulative weight distribution) of from 50 to 180 nm and, respectively, from 200 to 700 nm, in a ratio of from 70:30 to 30:70 by weight.

The chemical structure of the two graft polymers is preferably identical, but the shell of the coarse-particle graft polymer may in particular also be constructed in two stages.

Mixtures composed of the components where the latter comprise a coarse- and fine-particle graft polymer are described by way of example in DE-A 36 15 607. Mixtures composed of the components where the latter comprise a two-stage graft shell are known from EP-A 111 260.

The molding compositions of the invention can comprise, as component D), from 0 to 60% by weight, in particular up to 50% by weight, of further additives.

The molding compositions of the invention can comprise, as component D), from 0 to 5% by weight, preferably from 0.05 to 3% by weight, and in particular from 0.1 to 2% by weight, of at least one ester or amide of saturated or unsaturated aliphatic carboxylic acids having from 10 to 40, preferably from 16 to 22, carbon atoms with saturated aliphatic alcohols or amines having from 2 to 40, preferably from 2 to 6, carbon atoms.

The carboxylic acids may be monobasic or dibasic. Examples which may be mentioned are pelargonic acid, palmitic acid, lauric acid, margaric acid, dodecanedioic acid, behenic acid, and particularly preferably stearic acid, capric acid, and also montanic acid (a mixture of fatty acids having from 30 to 40 carbon atoms).

The aliphatic alcohols may be mono- to tetrahydric. Examples of alcohols are n-butanol, n-octanol, stearyl alcohol, ethylene glycol, propylene glycol, neopentyl glycol, pentaerythritol, preference being given to glycerol and pentaerythritol.

The aliphatic amines may be mono-, di- or triamines. Examples of these are stearylamine, ethylenediamine, propylenediamine, hexamethylenediamine, di(6-aminohexyl)amine, particular preference being given to ethylenediamine and hexamethylenediamine. Correspondingly, preferred esters or amides are glycerol distearate, glycerol distearate, ethylenediamine distearate, glycerol monopalmitate, glycerol trilaurate, glycerol monobehenate, and pentaerythrityl tetrastearate.

It is also possible to use mixtures of various esters or amides, or esters with amides combined, the mixing ratio here being as desired.

Examples of amounts of other usual additives D) are up to 40% by weight, preferably up to 30% by weight, of elastomeric polymers (also often termed impact modifiers, elastomers, or rubbers) other than C).

These are very generally copolymers which have preferably been built up from at least two of the following monomers: ethylene, propylene, butadiene, isobutene, isoprene, chloroprene, vinyl acetate, styrene, acrylonitrile and acrylates and/or methacrylates having from 1 to 18 carbon atoms in the alcohol component.

Polymers of this type are described, for example, in Houben-Weyl, Methoden der organischen Chemie, Vol. 14/1 (Georg-Thieme-Verlag, Stuttgart, Germany, 1961), pages 392-406, and in the monograph by C. B. Bucknall, “Toughened Plastics” (Applied Science Publishers, London, UK, 1977).

Fibrous or particulate fillers D) which may be mentioned are carbon fibers, glass fibers, glass beads, amorphous silica, asbestos, calcium silicate, calcium metasilicate, magnesium carbonate, kaolin, chalk, powdered quartz, mica, barium sulfate, and feldspar, the amounts used of these being up to 50% by weight, in particular up to 40% by weight.

Preferred fibrous fillers which may be mentioned are carbon fibers, aramid fibers, and potassium titanate fibers, particular preference being given to glass fibers in the form of E glass. The forms used of these may be the commercially available forms of chopped glass or rovings.

The fibrous fillers may have been surface-pretreated with a silane compound to improve compatibility with the thermoplastic.

Suitable silane compounds are those of the general formula

(X—(CH₂)ₙ)ₖ—Si—(O—CₘH₂ₘ₊₁₎₄₋ₖ

where the substituents are:

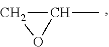

XNH₂—,

### HO—,

n is a whole number from 2 to 10, preferably from 3 to 4
m is a whole number from 1 to 5, preferably from 1 to 2
k is a whole number from 1 to 3, preferably 1.

Preferred silane compounds are aminopropyltrimethoxysilane, aminobutyltrimethoxysilane, aminopropyltriethoxysilane, aminobutyltriethoxysilane, and also the corresponding silanes which comprise a glycidyl group as substituent X.

The amounts generally used of the silane compounds for surface coating are from 0.05 to 5% by weight, preferably from 0.5 to 1.5% by weight, and in particular from 0.8 to 1% by weight (based on E).

Acicular mineral fillers are also suitable.

For the purposes of the invention, acicular mineral fillers are mineral fillers with very pronounced acicular character. An example which may be mentioned is acicular wollastonite. The L/D (length/diameter) ratio of the mineral is preferably from 8:1 to 35:1, with preference from 8:1 to 11:1. The mineral filler may optionally have been pretreated with the abovementioned silane compounds; however, this pretreatment is not essential.

Other fillers which may be mentioned are kaolin, calcined kaolin, wollastonite, talc, and chalk. As component D), the inventive thermoplastic molding compositions may comprise conventional processing aids, such as stabilizers, oxidation retarders, stabilizers to counter decomposition due to heat or due to ultraviolet light, lubricants, mold-release agents, colorants, such as dyes and pigments, nucleating agents, plasticizers, etc.

Examples which may be mentioned of oxidation retarders and heat stabilizers are sterically hindered phenols and/or phosphites, hydroquinones, aromatic secondary amines, such as diphenylamines, various substituted members of these groups, and mixtures of these in concentrations of up to 1% by weight, based on the weight of the thermoplastic molding compositions.

UV stabilizers which may be mentioned, and are generally used in amounts of up to 2% by weight, based on the molding composition, are various substituted resorcinols, salicylates, benzotriazoles, and benzophenones.

Colorants which may be added are inorganic pigments, such as titanium dioxide, ultramarine blue, iron oxide, and carbon black, and also organic pigments, such as phthalocyanines, quinacridones and perylenes, and also dyes, such as nigrosine and anthraquinones.

Nucleating agents which may be used are sodium phenylphosphinate, alumina, silica, and preferably talc.

Other lubricants and mold-release agents are usually used in amounts of up to 1% by weight. Preference is given to long-chain fatty acids (e.g. stearic acid or behenic acid), salts of these (e.g. calcium stearate or zinc stearate) or montan waxes (mixtures of straight-chain saturated carboxylic acids having chain lengths of from 28 to 32 carbon atoms), or calcium montanate or sodium montanate, or low-molecular-weight polyethylene waxes or low-molecular-weight polypropylene waxes.

Examples of plasticizers which may be mentioned are dioctyl phthalates, dibenzyl phthalates, butyl benzyl phthalates, hydrocarbon oils and N-(n-butyl)benzenesulfonamide.

The inventive molding compositions may also comprise from 0 to 2% by weight of fluorine-containing ethylene polymers. These are polymers of ethylene with a fluorine content of from 55 to 76% by weight, preferably from 70 to 76% by weight.

Examples of these are polytetrafluoroethylene (PTFE), tetrafluoroethylene-hexafluoropropylene copolymers and tetrafluoroethylene copolymers with relatively small proportions (generally up to 50% by weight) of copolymerizable ethylenically unsaturated monomers. These are described, for example, by Schildknecht in “Vinyl and Related Polymers”, Wiley-Verlag, 1952, pages 484-494 and by Wall in “Fluoropolymers” (Wiley Interscience, 1972).

These fluorine-containing ethylene polymers have homogeneous distribution in the molding compositions and preferably have a particle size d₅₀ (numeric average) in the range from 0.05 to 10 μm, in particular from 0.1 to 5 μm. These small particle sizes can particularly preferably be achieved by the use of aqueous dispersions of fluorine-containing ethylene polymers and the incorporation of these into a polyester melt.

The inventive thermoplastic molding compositions may be prepared by methods known per se, by mixing the starting components in conventional mixing apparatus, such as screw extruders, Brabender mixers or Banbury mixers, and then extruding them. The extrudate may be cooled and comminuted. It is also possible to premix individual components and then to add the remaining starting materials individually and/or likewise in a mixture. The mixing temperatures are generally from 230 to 290° C.

In another preferred procedure, components B) and C), and also optionally D), can be mixed with a polyester prepolymer, compounded, and pelletized. The resultant pellets are then solid-phase-condensed, continuously or batchwise, under an inert gas, at a temperature below the melting point of component A) until the desired viscosity has been reached.

The inventive thermoplastic molding compositions feature good processability and good flowability together with good mechanical properties.

These materials are suitable for producing fibers, foils, and moldings of any type, in particular for applications as plugs, switches, housing parts, housing covers, headlamp bezels, shower heads, fittings, smoothing irons, rotary switches, stove controls, fryer lids, door handles, (rear) mirror housings, (tailgate) screen wipers, or sheathing for optical conductors.

Electrical and electronic applications which can be produced using the improved-flow polyesters are plugs, plug components, plug connectors, cable harness components, cable mounts, cable mount components, three-dimensionally injection-molded cable mounts, electrical connector elements, mechatronic components, and optoelectronic components.

Possible uses in automobile interiors are dashboards, steering column switches, seat components, headrests, center consoles, gearbox components, and door modules, and possible automobile exterior components are door handles, headlamp components, exterior mirror components, windshield washer components, windshield washer protective housings, grilles, roof rails, sunroof frames, and exterior bodywork parts.

Possible uses of the improved-flow polyester in the kitchen and household sector are production of components for kitchen equipment, e.g. fryers, smoothing irons, buttons, and also garden and leisure sector applications, such as components for irrigation systems or garden equipment. In the medical technology sector, it becomes simpler to produce inhaler housings and components of these via improved-flow polyesters.

### EXAMPLES

### Component A/1:

Polybutylene terephthalate with an intrinsic viscosity IV of 120 ml/g and with a carboxyl end group content of 34 mval/kg (Ultradur® B 2550 from BASF AG) (IV measured in 0.5% strength by weight solution of phenol/o-dichlorobenzene), 1:1 mixture at 25° C.

### Component B-1:

Aerosil® R8200, a hydrophobically modified fumed SiO₂ of average particle size 15 nm (transmission electron microscopy) with a hexamethyldisilazane-hydrophobicized particle surface, BET specific surface area of about 160 m²/g, and pH of at least 5 for a 4% strength dispersion.

B 1a: in the form of 20% strength by weight masterbatch in component A)
B 1b: in the form of 20% strength by weight masterbatch in component C)
B 1c: in the form of 20% strength by weight masterbatch in component C/1 comp)

### Component B-2 (Comparative Example):

Aerosil® 380, an unmodified fumed SiO₂ of average particle size 7 nm (transmission electron microscopy) with a hydrophilic particle surface, BET surface area of about 380 m²/g, and pH of from 3.7 to 4.7 for a 4% strength dispersion.

B 2a: in the form of 20% strength by weight masterbatch in component A)
B 2b: in the form of 20% strength by weight masterbatch in component C)

### Component C:

Emulsion polymerization using potassium peroxodisulfate as initiator was used to produce 50% by weight of n-butyl acrylate and 50% by weight of a graft made of styrene-acrylonitrile (75:25). Average particle size was 150 nm (measured by means of ultracentrifuge).

### Component C/1 Comp (for Comparison)

Bulk polymerization was used to produce a styrene-acrylonitrile copolymer with an intrinsic viscosity of 80 ml/g (determined to DIN 53726 or DIN EN ISO 1628-2 in 0.5% strength by weight DMF solution at 25° C.) using 75% by weight of styrene and 25% by weight of acrylonitrile. Molar mass (Mn) was about 85 000 g/mol (GPC in THF with PS calibration: stationary phase: 5 styrene-divinylbenzene gel columns (PLgel Mixed-B, Polymer Laboratories); THF 1.2 ml/min).

The molding compositions were produced as follows:

All of the specimens were produced via compounding in the melt in a ZSK-18 twin-screw extruder at 260° C. with throughput of 5 kg/h.

The test specimens used to determine properties were obtained by injection molding (injection temperature 260° C., melt temperature 80° C.).

Charpy impact resistance was determined without notch at −30° C. to ISO 179-2/1eU and with notch to ISO 179-1/1eA, and the tensile test was also determined to ISO 527-1.

Table 1 shows the properties of various comparative examples and of inventive examples, and the corresponding constitutions of the molding compositions.

| | Constitution in [% by weight] | | | | | | | | | | |
|---|---|---|---|---|---|---|---|---|---|---|---|
| | | | C/1 | | | | | | Tensile stress | Charpy without | Charpy with |
| Example | A | C | Comp | B 1a | B 1b | B 1c | B 2a | B 2b | [MPa] | notch [kJ/m²] | notch [kJ/m²] |
| 1 comp | 80 | 20 | — | — | — | — | — | — | 55.9 | 48.8 | 3.2 |
| 1 | 80 | 10 | — | — | 10 | — | — | — | 55.9 | 113.5 | 3.5 |
| 2 | 70 | 20 | — | 10 | — | — | — | — | 55.0 | 103.4 | 3.6 |
| 3 | 80 | — | — | — | 20 | — | — | — | 55.2 | 93.1 | 3.5 |
| 2 comp | 70 | 20 | — | — | — | — | 10 | — | 46.9 | 24.1 | 3.5 |
| 3 comp | 80 | 10 | — | — | — | — | — | 10 | 55.8 | 54.3 | 3.1 |
| 4 comp | 70 | 30 | — | — | — | — | — | — | 53 | 88.6 | 3.6 |
| 4 | 70 | 20 | — | — | 10 | — | — | — | 51.8 | 117 | 3.7 |
| 5 | 70 | 10 | — | — | 20 | — | — | — | 50.2 | 91.4 | 3.6 |
| 6 | 60 | 30 | — | 10 | — | — | — | — | 51.5 | 78.9 | 3.7 |
| 5 comp | 60 | 30 | — | — | — | — | 10 | — | 44 | 41.7 | 3.4 |
| 6 comp | 70 | 20 | — | — | — | — | — | 10 | 51.7 | 39.7 | 2.6 |
| 7 comp | 60 | 40 | — | — | — | — | — | — | 50.9 | 82.8 | 3.7 |
| 7 | 60 | 20 | — | — | 20 | — | — | — | 47.9 | 93.1 | 3.9 |
| 8 | 40 | 40 | — | 20 | — | — | — | — | 48.4 | 85.1 | 4.4 |
| 8 comp | 70 | — | 30 | — | — | — | — | — | 47.5 | 78.8 | 2.1 |
| 9 comp | 70 | — | 20 | — | — | 10 | — | — | 42.3 | 44 | 2.2 |
| 10 comp | 60 | — | 30 | 10 | — | — | — | — | 52.9 | 31.6 | 1.9 |
| 11 comp | 80 | — | 20 | — | — | — | — | — | 56.3 | 64.4 | 2.9 |
| 12 comp | 80 | — | 10 | — | — | 10 | — | — | 58.2 | 63.8 | 3.6 |
| 13 comp | 70 | | 20 | 10 | | | | | 46.6 | 42.5 | 2.1 |

1-9. (canceled)

10. A thermoplastic molding composition comprising
A) from 10 to 98.95% by weight of at least one thermoplastic polyester,
B) from 0.05 to 30% by weight
of at least one nanoparticulate oxide and/or oxide hydrate of at least one metal or of at least one semimetal with a number-average primary particle diameter of from 0.5 to 50 nm and with a hydrophobic particle surface,
C) from 1 to 60% by weight of at least one graft polymer, composed of
c₁) from 20 to 80% by weight of a graft base composed of an elastomeric polymer based on alkyl acrylates having from 1 to 8 carbon atoms in the alkyl moiety and/or dienes having a glass transition temperature below 10° C.
c₂) from 20 to 80% by weight of a graft composed of
c₂₁) from 60 to 95% by weight of styrene or of substituted styrenes of the general formula I 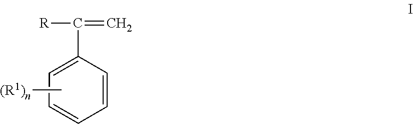
where R is an alkyl radical having from 1 to 8 carbon atoms or a hydrogen atom, and R¹ is an alkyl radical having from 1 to 8 carbon atoms, and n is 1, 2, or 3, and
c₂₂) from 5 to 40% by weight of at least one unsaturated nitrile,
D) from 0 to 60% by weight of further additives,
where the total of the percentages by weight of components A) to D) does not exceed 100%.

11. The thermoplastic molding composition according to claim 10, wherein the methanol-wettability of component B) is at least 50%.

12. The thermoplastic molding composition according to claim 10, wherein the BET specific surface area of component B) to DIN 66131 is from 50 to 300 m²/g.

13. The thermoplastic molding composition according to claim 11, wherein the BET specific surface area of component B) to DIN 66131 is from 50 to 300 m²/g.

14. The thermoplastic molding composition according to claim 10 comprising, as component B), an amorphous oxide and/or oxide hydrate of silicon with a number-average primary particle diameter of from 0.5 to 50 nm.

15. The thermoplastic molding composition according to claim 13 comprising, as component B), an amorphous oxide and/or oxide hydrate of silicon with a number-average primary particle diameter of from 0.5 to 50 nm.

16. The thermoplastic molding composition according to claim 10, wherein the number-average primary particle diameter of component B) is from 1 to 20 nm.

17. The thermoplastic molding composition according to claim 10, wherein the number-average primary particle diameter of component B) is from 1 to 10 nm.

18. The thermoplastic molding composition according to claim 15, wherein the number-average primary particle diameter of component B) is from 1 to 10 nm.

19. The thermoplastic molding composition according to claim 10, wherein component B) is present in a form that has been hydrophobically modified by using a silane.

20. The thermoplastic molding composition according to claim 10, wherein component B) is present in a form that has been hydrophobically modified by using a hexamethyldisilazane.

21. The thermoplastic molding composition according to claim 18, wherein component B) is present in a form that has been hydrophobically modified by using a hexamethyldisilazane.

22. The thermoplastic molding composition according to claim 10, wherein component B) is fumed silicon dioxide the surface of which is in a form that has been hydrophobically modified.

23. The thermoplastic molding composition according to claim 21, wherein component B) is fumed silicon dioxide the surface of which is in a form that has been hydrophobically modified.

24. A process for producing fibers, foils, or moldings which comprises utilizing the thermoplastic molding compositions according to claim 10.

25. A fiber, a foil, or a molding, obtainable from the thermoplastic molding compositions according to claim 10.
